(19) United States
(12) Patent Application Publication
(10) Pub. No.: US 2019/0087918 A1
(43) Pub. Date: Mar. 21, 2019

(54) LOGISTICS METHOD AND SYSTEM FOR PLANNING SEQUENCING OF BULK MATERIAL CONTAINERS

(71) Applicant: Halliburton Energy Services, Inc., Houston, TX (US)

(72) Inventors: Bryan John Lewis, Duncan, OK (US); Austin Carl Schaffner, Duncan, OK (US); Timothy Holiman Hunter, Duncan, OK (US)

(21) Appl. No.: 16/080,955

(22) PCT Filed: Apr. 4, 2016
(86) PCT No.: PCT/US2016/025890

§ 371 Date: Aug. 29, 2018

(51) Int. Cl. G06Q 50/02; G06Q 10/06; G06Q 10/08

(52) U.S. Cl. CPC G06Q 50/02; G06Q 10/087; G06Q 10/06312

(57) ABSTRACT

In accordance with presently disclosed embodiments, a method and computer system for scheduling and timing the movements of a plurality of bulk material containers into position to output bulk materials directly into a blender inlet are provided. The disclosed sequencing techniques may include planning a sequence and timing of bulk material container movement and usage during operations at a job site. The planned sequence and timing of these operations may be developed to reliably provide the correct material type and quantity to a blender at a desired time to meet a treatment design profile. In addition, the disclosed system and method may monitor the real time operations on location to track how closely the movements of bulk material containers conform to the schedule developed for the well treatment.

### TECHNICAL FIELD

The present disclosure relates generally to transferring bulk materials, and more particularly, to a method and computer system for planning and executing an operational sequence of bulk material container movements at a job site.

### BACKGROUND

During the drilling and completion of oil and gas wells, various wellbore treating fluids are used for a number of purposes. For example, high viscosity gels are used to create fractures in oil and gas bearing formations to increase production. High viscosity and high density gels are also used to maintain positive hydrostatic pressure in the well while limiting flow of well fluids into earth formations during installation of completion equipment. High viscosity fluids are used to flow sand into wells during gravel packing operations. The high viscosity fluids are normally produced by mixing dry powder and/or granular materials and agents with water at the well site as they are needed for the particular treatment. Systems for metering and mixing the various materials are normally portable, e.g., skid- or truck-mounted, since they are needed for only short periods of time at a well site.

The powder or granular treating material (bulk material) is normally transported to a well site in a commercial or common carrier tank truck. Once the tank truck and mixing system are at the well site, the bulk material must be transferred or conveyed from the tank truck into a supply tank for metering into a blender as needed. Well sites typically include one or more supply tanks that are filled pneumatically on location and then connected to the blender through a series of belts (or auger conveyors in some marine applications). The supply tanks provide a large connected capacity of bulk material to be supplied to the blender. Discharge gates on the supply tanks output bulk material from the supply tanks to the conveyors, which then meter the bulk material to the blender.

Recent developments in bulk material handling operations involve the use of portable containers for transporting dry material about a well location. The containers can be brought in on trucks, unloaded, stored on location, and manipulated about the well site when the material is needed. The containers are generally easier to manipulate on location than a large supply tank trailer. However, the many separate containers do not provide a large connected capacity to the blender and, therefore, the containers must be changed out frequently to complete a wellbore treatment process. It is important to coordinate movement of such bulk material containers about the well site and the release of desired bulk materials from the containers into the blender to successfully perform the wellbore treatment.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a schematic block diagram of a bulk material handling system suitable for sequencing between containers of bulk material to provide a continuous material flow to a blender, in accordance with an embodiment of the present disclosure;

FIG. 2 is a schematic block diagram of a control system and related electronics for sequencing bulk material containers, in accordance with an embodiment of the present disclosure;

FIG. 3 is a process flow diagram of a method for planning a sequence of moving and emptying a plurality of bulk material containers at a job site, in accordance with an embodiment of the present disclosure;

FIG. 4 is a plot illustrating a profile of bulk material usage with respect to time, in accordance with an embodiment of the present disclosure;

FIG. 5 is a table illustrating a sand use rate profile charted with respect to time, in accordance with an embodiment of the present disclosure;

FIG. 6 is a table illustrating a container swap schedule for portable bulk material containers, in accordance with an embodiment of the present disclosure; and

FIG. 7 is a process flow diagram of a method for implementing an operational sequence of bulk material containers in real time, in accordance with an embodiment of the present disclosure.

### DETAILED DESCRIPTION

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure.

Certain embodiments according to the present disclosure may be directed to systems and methods for efficiently managing bulk material (e.g., bulk solid or liquid material). Bulk material handling systems are used in a wide variety of contexts including, but not limited to, drilling and completion of oil and gas wells, concrete mixing applications, agriculture, and others. The disclosed embodiments are directed to systems and methods for efficiently delivering bulk material from a plurality of bulk material containers into a blender inlet of a blender unit at a job site. Disclosed embodiments may include a method and computer system for scheduling and timing a sequence for moving a plurality of bulk material containers into position to output bulk materials directly into the blender inlet at a desired time. The disclosed techniques may be used to efficiently handle any desirable bulk material having a solid or liquid constituency including, but not limited to, sand, proppant, gel particulate, diverting agent, dry-gel particulate, liquid additives, acid, chemicals, cement, and others.

In currently existing on-site bulk material handling applications, dry material (e.g., sand, proppant, gel particulate, or dry-gel particulate) may be used during the formation of treatment fluids. In such applications, the bulk material is often transferred between transportation units, storage tanks, blenders, and other on-site components via pneumatic transfer, sand screws, chutes, conveyor belts, and other components. Recently, a new method for transferring bulk material to a hydraulic fracturing site involves using portable containers to transport the bulk material. The containers can be brought in on trucks, unloaded, stored on location, and manipulated about the site when the material is needed. These containers generally include a discharge gate at the bottom that can be actuated to empty the material contents of the container at a desired time.

Bulk material containers are typically transported about a job site via forklifts or other transportation components that move one portable container at a time into position for outputting bulk material toward a blender inlet. In general, only a few containers of bulk material are connected to the blender at any time to provide connected capacity. As a result, the time and method of sequencing the movement of containers can be an important design feature, especially as the containerized bulk material management system is used in more operationally complex jobs (e.g., having larger bulk material use rates or more types of bulk material used during the job). There is little or no room for operator error when loading, unloading, delivering, moving, positioning, opening, and closing the many bulk material containers at a well site in a coordinated manner.

The disclosed systems and methods for sequencing the movement of bulk material containers are designed to address and eliminate the shortcomings associated with existing container handling systems. Specifically, the disclosed sequencing techniques may include planning a sequence and timing of bulk material container movement and usage during operations at a job site. The planned sequence and timing of these operations may be developed to reliably provide the correct material type and quantity to a blender at a desired time to meet a treatment design profile. The system and method may be used for sequencing movement of proppant, dry gel, liquid additives, acid chemicals, cement, or any other bulk material that must be mixed on location to produce a treatment fluid.

The disclosed sequencing method may decrease the likelihood that a job failure could occur due to timing errors by a system operator. The timing of container movement to and from the support structure, as well as the delivery of containers to the well site, is important for enabling the job to continue as desired. Using the disclosed automated sequencing, the bulk material handling system may effectively direct operators (e.g. forklift operators) on location to move bulk material containers to desired locations in time to meet the requirements of the treatment profile. That way, if a situation occurs at the well site that might distract the sand operator during the time that multiple forklift movements are needed, the automated system ensures that the correct next order is issued to a forklift operator in sufficient time to continue the supply of bulk material to the blender.

In addition, the disclosed system and method may monitor the real time operations on location to track how closely the movements of bulk material containers conform to the schedule developed for the well treatment. The disclosed sequencing system and method provides active notification of the next move that should be completed in the sequence of bulk material container movements throughout the well treatment process. The system and method may also provide assistance in determining which of several competing operations should be completed first in the sequence. This active notification and prioritization helps the well treatment proceed on track when quick timing is needed for container switching and replacement on site. This may be the case, for example, toward the end of a stage of the well treatment process when proppant usage is at its highest rate. Thus, the disclosed embodiments may offer improved service quality and reliability of operations at the well site, particularly while performing complex treatments.

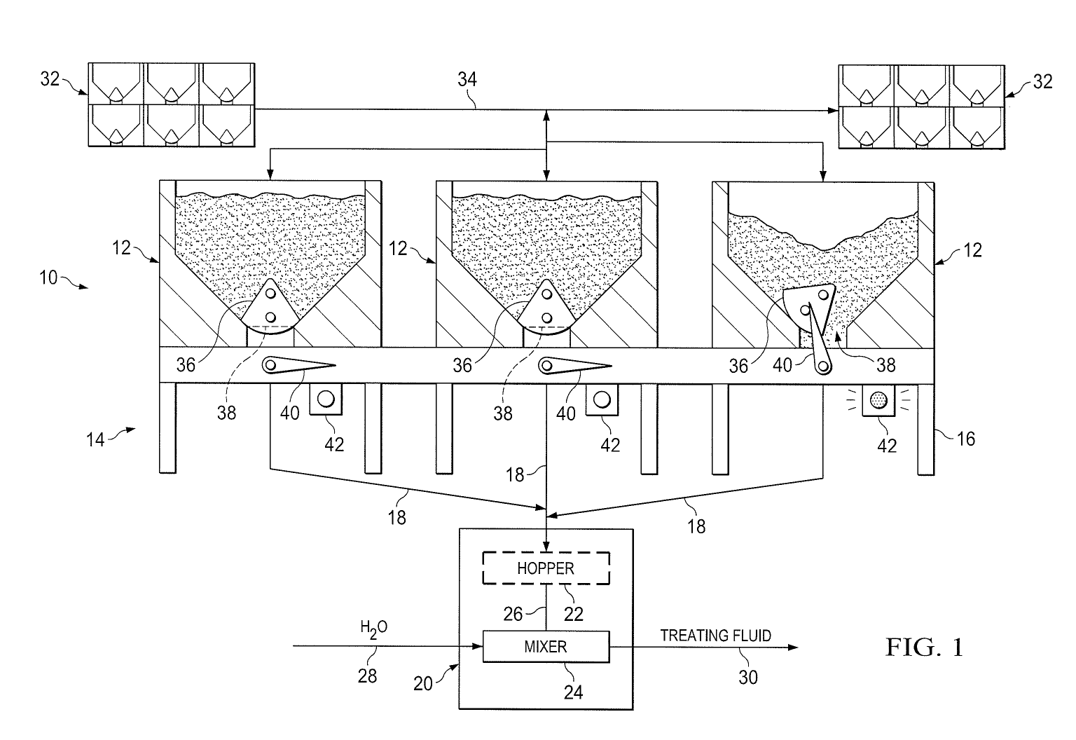

Turning now to the drawings, FIG. 1 is a block diagram of a bulk material handling system 10. The system 10 includes one or more containers 12 elevated on a support structure 14 and holding a quantity of bulk material (e.g., solid or liquid treating material). The containers 12 may each utilize a gravity feed to provide a controlled, i.e. metered, flow of bulk material at an outlet 18. The containers 12 are separate from each other and independently transportable about the job site (e.g., for placement on or removal from the support structure 14).

In the illustrated embodiment, the support structure 14 may include a frame 16 for receiving and holding the containers 12 and a plurality of gravity feed outlets 18 for directing bulk material away from the respective containers 12. The outlets 18 may be coupled to and extend from the frame 16. The outlets 18 may utilize a gravity feed to provide a controlled, i.e. metered, flow of bulk material from the containers 12 to a blender unit 20.

Although shown as just one support structure 14 in FIG. 1, other embodiments of the bulk material handling system 10 may include one or more bulk material containers 12 disposed on separate support structures 14 that all feed into the blender unit 20. For example, the support structures 14 may each hold a single container 12. In other embodiments, the support structures 14 may each hold multiple containers 12. In still other embodiments, one support structure 14 may hold a single container 12 while another support structure 14 holds multiple containers.

As illustrated, the blender unit 20 may include a hopper 22 and a mixer 24 (e.g., mixing compartment). The blender unit 20 may also include a metering mechanism 26 for providing a controlled, i.e. metered, flow of bulk material from the hopper 22 to the mixer 24. However, in other embodiments the blender unit 20 may not include the hopper 22, such that the outlets 18 of the support structure 14 may provide bulk material directly into the mixer 24.

Water and other additives may be supplied to the mixer 24 (e.g., mixing compartment) through a fluid inlet 28. As those of ordinary skill in the art will appreciate, the fluid inlet 28 may include more than the one input flow line illustrated in FIG. 1. The bulk material and water may be mixed in the mixer 24 to produce (at an outlet 30) a hydraulic fracturing fluid, a mixture combining multiple types of proppant, proppant/dry-gel particulate mixture, sand/sand-diverting agents mixture, cement slurry, drilling mud, a mortar or concrete mixture, or any other fluid mixture for use on location. The outlet 30 may be coupled to a pump for transporting the treating fluid to a desired location (e.g., a hydrocarbon recovery well) for a treating process.

It should be noted that the disclosed containers 12 may be utilized to provide bulk material for use in a variety of treating processes. For example, the disclosed systems and methods may be utilized to provide proppant materials into fracture treatments performed on a hydrocarbon recovery well. In other embodiments, the disclosed techniques may be used to provide other materials (e.g., non-proppant) for diversions, conductor-frac applications, cement mixing, drilling mud mixing, and other fluid mixing applications.

As illustrated, the containers 12 may be elevated above an outlet location via the frame 16. The support structure 14 is designed to elevate the containers 12 above the level of the blender inlet (e.g., blender hopper 22 and/or mixing tub 24) to allow the bulk material to gravity feed from the containers 12 to the blender unit 20. This way, the containers 12 are able to sit on the frame 16 of the support structure 14 and output bulk material directly into the blender unit 20 via the gravity feed outlets 18 of the support structure 14. In some embodiments, the support structure 14 (with the frame 16 and the gravity feed outlets 18) may be integrated into the blender unit 20. In this manner, the system 10 may be a single integrated unit for receiving one or more containers 12 on the support structure 14, feeding bulk material from the containers 12 to the blender inlet, and mixing the bulk material with one or more fluids at the mixer 24 to produce the treatment fluid.

Although shown as supporting three containers 12, other embodiments of the frame 16 may be configured to support other numbers (e.g., 1, 2, 4, 5, 6, 7, 8, or more) of containers 12. The exact number of containers 12 that the support structure 14 can hold may depend on a combination of factors such as, for example, the volume, width, and weight of the containers 12 to be disposed thereon.

In any case, the containers 12 may be completely separable and transportable from the frame 16, such that any container 12 may be selectively removed from the frame 16 and replaced with another container 12. That way, once the bulk material from one container 12 runs low or empties, a new container 12 may be placed on the frame 16 to maintain a steady flow of bulk material to an outlet location. In some instances, a container 12 may be closed before being completely emptied, removed from the frame 16, and replaced by a container 12 holding a different type of bulk material to be provided to the outlet location.

It should be noted that the disclosed system 10 may be used in other contexts as well. For example, the bulk material handling system 10 may be used in concrete mixing operations (e.g., at a construction site) to dispense aggregate from the containers 12 through the outlets 18 into a concrete mixing apparatus (blender 20). In addition, the bulk material handling system 10 may be used in agriculture applications to dispense grain, feed, seed, or mixtures of the same. Still other applications may be realized for transporting bulk material via containers 12 to an elevated location on a support structure 14 and dispensing the bulk material in a metered fashion through the outlets 18.

A portable bulk storage system 32 may be provided at the site for storing one or more additional containers 12 of bulk material to be positioned on the frame 16 of the support structure 14. The bulk material containers 12 may be transported to the desired location on a transportation unit (e.g., truck). The bulk storage system 32 may be the transportation unit itself or may be a skid, a pallet, or some other holding area. One or more containers 12 of bulk material may be transferred from the storage system 32 onto the support structure 14, as indicated by arrow 34. This transfer may be performed by lifting the container 12 via a hoisting mechanism, such as a forklift, a crane, or a specially designed container management device.

When the one or more containers 12 are positioned on the support structure 14, discharge gates 36 on one or more of the containers 12 may be opened, allowing bulk material to flow from the containers 12 into the respective outlets 18 of the support structure 14. The outlets 18 may then route the flow of bulk material directly into a blender inlet (e.g., into the hopper 22 or mixer 24) of the blender unit 20.

After one or more of the containers 12 on the support structure 14 are emptied, the empty container(s) 12 may be removed from the support structure 14 via a hoisting mechanism. In some embodiments, the one or more empty containers 12 may be positioned on another bulk storage system 32 (e.g., a skid, a pallet, or some other holding area) until they can be removed from the site and/or refilled. In other embodiments, the one or more empty containers 12 may be positioned directly onto a transportation unit for transporting the empty containers 12 away from the site. It should be noted that the same transportation unit used to provide one or more filled containers 12 to the location may then be utilized to remove one or more empty containers 12 from the site.

As illustrated, the containers 12 may each include a discharge gate 36 for selectively dispensing or blocking a flow of bulk material from the container 12. In some embodiments, the discharge gate 36 may include a rotary clamshell gate, as shown. However, other types of discharge gates 36 that can be actuated open and closed may be used. When the discharge gate 36 is closed, as shown on the left-hand and centrally positioned containers 12A and 12B, the gate 36 may prevent bulk material from flowing from the corresponding container 12 to the outlet 18. The discharge gate 36 may be selectively actuated into an open position (as shown on the right-hand positioned container 12C) to release the bulk material from the container 12. When rotary clamshell gates are used, this actuation may involve rotating the discharge gate 36 about a pivot point relative to the container 12 to uncover an opening 38 at the bottom of the container 12, thereby allowing bulk material to flow through the opening 38 and into the outlet 18. When linearly actuated gates are used, this actuation may involve linearly translating the discharge gate 36 relative to the container 12 to uncover the opening 38. When it is desired to stop the flow of bulk material, or once the container 12 is emptied, the discharge gate 36 may then be actuated (e.g., rotated or translated) back to the closed position to block the flow of bulk material.

In some embodiments, the support structure 14 may include one or more actuators 40 used to actuate the discharge gates 36 of whatever containers 12 are positioned on the support structure 14. The one or more actuators 40 may be entirely separate from the containers 12 and their corresponding discharge gates 36. That is, the one or more actuators 40 and the discharge gates 36 may not be collocated on the same structure. The same actuators 40 may be used to open and/or closed the discharge gates 36 of multiple containers 12 that are positioned on the support structure 14 over time. The one or more actuators 40 may be rotary actuators, linear actuators, or any other desired type of actuators for engaging and moving the discharge gates 36 of the containers 12 between closed and open positions. The actuators 40 may be automated and, in some instances, may allow for manual override of the automated system.

The support structure 14 may also include one or more indicators 42 (e.g., indicator lights) disposed on the support structure 14 for providing various information about the operating state of the support structure 14 and/or the containers 12 disposed thereon. For example, in the illustrated embodiment, the support structure 14 may include at least one indicator 42 corresponding to each actuator 40 on the support structure 14. The indicators 42 may include lights designed to indicate whether the discharge gates 36 of the containers 12 disposed on the support structure 14 are in an open position or in a closed position, based on the operating state of the corresponding actuators 40.

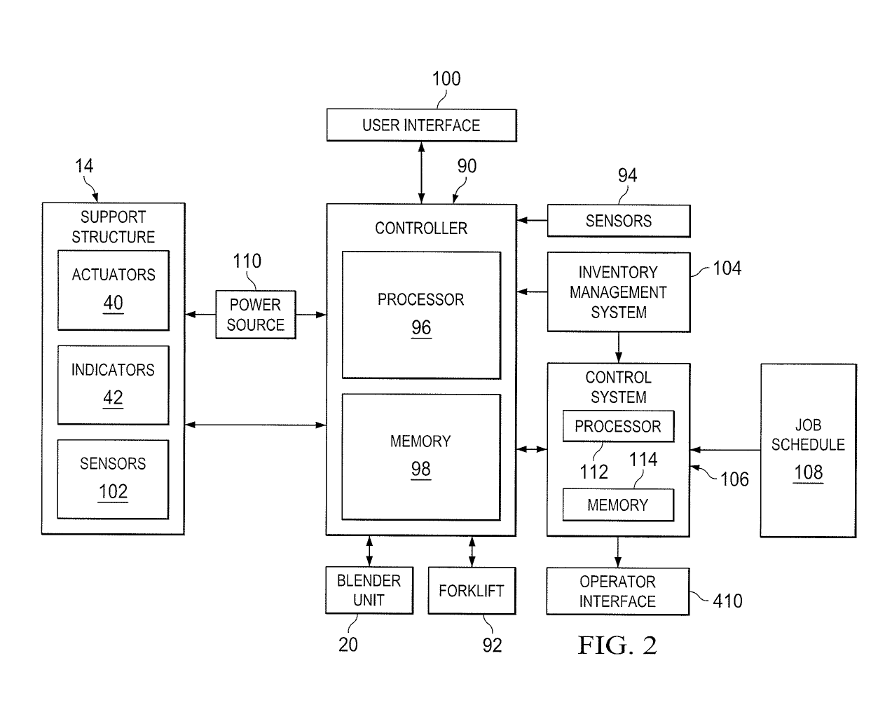

In presently disclosed embodiments, the bulk material handling system 10 may utilize a control system for controlling actuation of the discharge gates 36 of the containers 12 on the support structure 14. More specifically, the control system may control discharge gate sequencing, system message reporting to an operator, and data processing for various calculations used in the gate sequencing and bulk material handling processes. FIG. 2 is a block diagram illustrating one such control system 90 used in conjunction with the support structure 14 and various other on-site components to control sequencing of bulk material containers and other processes. Operation of such a control system 90 is described in greater detail in PCT Application No. PCT/US2015/062640.

The portable support structure 14 may include a number of electronic components, and these components may be communicatively coupled (e.g., via a wired connection or wirelessly) to one or more controllers 90 (e.g., automated control system) at the well site. The control system 90 may be communicatively coupled to several other well site components including, but not limited to, the blender unit 20, a hoisting mechanism (e.g., forklift) 92, and various sensors 94.

The control system 90 utilizes at least a processor component 96 and a memory component 98 to monitor and/or control various operations and bulk material inventory at the well site. For example, one or more processor components 96 may be designed to execute instructions encoded into the one or more memory components 98. Upon executing these instructions, the processors 96 may provide passive logging of the operational states of one or more components at the well site, as well as the amount, type, and location of bulk materials at the well site. In some embodiments, the one or more processors 96 may execute instructions for controlling operations of certain well site components (e.g., support structure electronics). This may help to control sequencing of discharge gates on the bulk material containers and other operations related to bulk material transfer at the well site.

As shown, the controller 90 may be coupled to a graphical user interface (GUI) 100, which enables an operator to input instructions for execution by the control system 90. The GUI 100 may also output data relating to the operational state of the bulk material handling system.

As shown, the control system 90 may be communicatively coupled to a number of sensors 94 disposed on the support structure 14 and/or about the well site. Based on feedback from these sensors 94, the control system 90 may determine when to actuate discharge gates to switch between different bulk material containers that are positioned on the support structure 14. The control system 90 may also be communicatively coupled to a number of controllable components disposed on the support structure 14, the blender unit 20, and/or the forklift 92. The control system 90 may actuate certain of these controllable components based on sensor feedback.

The support structure 14 may include a number of electronic components such as, for example, the automated actuators 40 described above with reference to FIG. 1. These actuators 40 may be controlled to open and/or close a discharge gate of one or more containers elevated on the support structure 14. The support structure 14 may also include one or more indicators 42 (e.g., indicator lights) disposed on the support structure for providing various information about the operating state of the support structure 14.

In addition, the support structure 14 may include various sensors 102 (e.g., fill level sensors, cameras, load cells, etc.) designed to take measurements and provide sensor feedback to the control system 90. The sensors 102 may be used to detect levels of bulk material present in the hopper and/or output chutes, information regarding the number of containers disposed on the support structure 14, as well as the fill level of bulk material within the individual containers on the support structure 14. The control system 90 may actuate the discharge gates on different containers with precisely controlled timing based on the received sensor feedback.

The controller 90, the support structure electronics, or both, may utilize power from an external power source 110, as shown. In other embodiments, the support structure 14 may include its own power source 110 for operating the onboard electronics and sensors.

The sensors 94 may include one or more load cells or bin full switches for tracking a level of bulk material in a portable container and indicating whether the container is empty, full, or partially full. Such sensors 94 may be used for any given container, the blender hopper, a silo (not shown), a forklift, or any other component at the well site.

In some embodiments, the controller 90 may be communicatively coupled to an inventory management system 104 that monitors the inventory of bulk material on location. Operation of such an inventory management system 104 is described in greater detail in PCT Application No. PCT/US2015/061618. The inventory management system 104 may include a separate control/monitoring system or may be incorporated into the controller 90. The inventory management system 104 may track bulk material inventory on location through the use of RFID technology or other identification tracking techniques. Each portable container may feature an identification component (e.g., RFID tag) used to provide an indication of the particle size, bulk volume, weight, type, material, and/or supplier of the bulk material present in the container. The inventory management system 104 may be communicatively coupled to an RFID reader disposed in proximity to the containers being moved about the well site.

The controller 90 may provide control signals to the actuators 40 used to open and/or close the container discharge gates with appropriate timing for maintaining a steady supply of bulk material to the blender unit 20. In some embodiments, the control system 90 may control the actuators 40 to open only one container at a time to output bulk material to the blender unit. In other embodiments, the control system may control the actuators 40 to open multiple containers at the same time to output bulk material to the blender unit.

The GUI 100 may enable an operator to select a sequence in which the containers disposed on the support structure 14 are to be actuated to release their bulk material to the blender. For example, the GUI 100 may allow an operator to make selections of the “next” container (or multiple containers) to be opened in the sequence, or to select a list of several containers to be individually opened in a selected order. The control system 90 may provide alerts through the GUI 100 or other means to well site operators as needed.

An operator may use the GUI 100 to manually sequence and initiate gate actuations of any desirable container on the support structure 14. Additional manual override techniques may also be available using, for example, manual hydraulic, pneumatic, or mechanical controls. For example, an operator may manually open and/or close valves that are part of the hydraulic actuation system on the support structure to actuate discharge gates of different containers on the structure 14. In addition, an operator may manually open and/or close the discharge gates directly using, for example, a mechanical lever inserted through a portion of the gate. These manual override techniques may allow the bulk material handling system to continue to operate during a temporary time in the event that other electrical, hydraulic, or control components malfunction.

In addition to the components described above, the system 10 may include a tool/computer system 106 designed to develop and/or control a job schedule of when bulk material will be delivered to the blender and when new deliveries of bulk material will be received at the well site. This tool/computer system 106 may be a control system designed to receive an input of a designed job schedule 108 and determine and implement an optimized schedule/procedure for delivering desired bulk material containers to the blender at a correct time. The input job schedule 108 may include information (e.g., pumping rate, bulk material concentration, and bulk material type) about treatment fluids to be pumped into the well in one or more stages.

The schedule for delivering and moving bulk material containers about the well site may be optimized to minimize the number of times a container is moved while maximizing the amount of time between swapping containers on the support structure 14. The optimized schedule may include information regarding how many containers are needed on site, timing for moving or changing out containers, inventory management, and a desired order for performing tasks most efficiently. In some embodiments, the optimized schedule may include information regarding a number of full or partially full portable containers at a job site, a number of empty portable containers at the job site, a number of portable containers or trailers in transit relative to the job site, or a total number of portable containers, forklift drivers, trailers, and truck drivers. As described in detail below, the functions of the control system 106 may be divided into three main categories: pre-job planning, real-time operation, and post-job analysis.

As illustrated, the control system 106 for scheduling, operating, and monitoring movement of bulk material containers about the job site may be separate from the discharge gate sequencing control system 90 and the inventory management system 104. Although the control system 106 is separate in function, and can be used as a standalone application, the control system 106 may be physically combined into the other control system 90 and/or the inventory management system 104. That way, a single control system might control the overall logistics of bulk material delivery to the blender, including planning the job, scheduling product delivery, sequencing the containers onto the blender, and timing gate openings to maintain a flow of bulk material to the blender to meet the job schedule 108.

The control system 106 utilizes at least a processor component 112 and a memory component 114 to determine the optimized schedule and monitor/control various operations at the well site based on the schedule. One or more processor components 112 may be designed to execute instructions encoded into the one or more memory components 114. Upon executing these instructions, the processors 112 may provide passive logging of the operational states of one or more components at the well site, as well as the amount, type, and location of bulk materials at the well site. In some embodiments, the one or more processors 112 may execute instructions for controlling operations of certain well site components (e.g., support structure electronics, blender unit 20, hoisting mechanism 92, etc.). In some embodiments, the processors 112 may execute instructions for outputting commands to various operator interfaces 410 (e.g., instructing forklift operators to move specific containers). This may help to control placement of containers about the well site and other operations related to bulk material transfer at the well site.

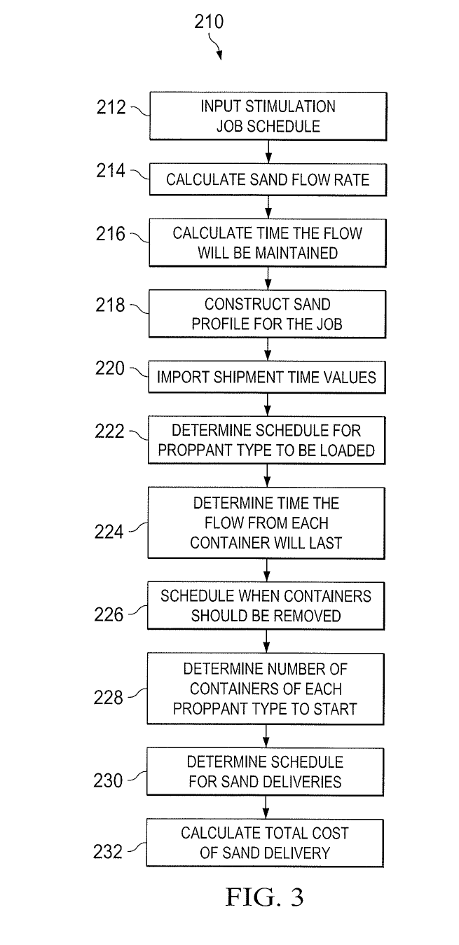

FIG. 3 illustrates a method 210 for performing pre-job planning via the control system 106. This method 210 may be executed entirely prior to performing any bulk material transfer operations at the well site. The objective of the pre-job planning function is to determine the resources needed to perform the desired job. For example, the pre-job planning method 210 may be used to determine a number of bulk material containers, a number of delivery trucks, speed requirements for a forklift driver, a schedule of bulk material deliveries, and a total cost of the bulk material delivery. It should be noted that additional steps (or fewer steps) may be implemented in other embodiments of the pre-job planning method 210, and some of the illustrated steps may be combined together or performed in different orders than as shown.

The method 210 may include importing or inputting (block 212) a stimulation job schedule (e.g., job schedule 108 of FIG. 2) into the control system (e.g., 106 of FIG. 2). The stimulation job schedule may be provided by a customer or designed through an iterative process by a stimulation engineer or team. The stimulation job schedule may provide detailed information about treatment fluids being pumped into the well in one or more stages. The stimulation job schedule may include the pumping rate, bulk material concentration, and bulk material type used for each stage of a treatment job. The stimulation job schedule may also include the total volume of fluid to be pumped in each stage of the job.

Each stage of the stimulation job may refer to a particular pumping interval, which may correspond to a specific location along the well. For example, different well treatments may be performed at different positions along the well. Each stage of the stimulation job may be separated by a mechanical barrier or liquid barrier. Each stage typically begins with pumping fluid downhole without sand (i.e., bulk material), then adding sand, ramping up the sand concentration, changing the sand type, increasing the concentration of sand further, and finally pumping fluid without sand again before placing the barrier.

Upon receiving the stimulation job schedule, the control system 106 may calculate (block 214) a sand flow rate for each stage of the stimulation schedule. The control system 106 may calculate the sand flow rate from the fluid pumping rate and sand concentration as specified according to the imported job schedule 108. The control system 106 may calculate (block 216) the time that this flow will need to be maintained for each stage, based on the fluid flow rate and the total fluid volume to be pumped as specified in the imported stimulation job schedule 108. The control system 106 may then construct (block 218) a sand profile for the complete stimulation job, based on the previously calculated sand rate and time for each stage. As described below, the sand profile may include information regarding a total amount of sand used and a sand usage rate for different types of sand over time.

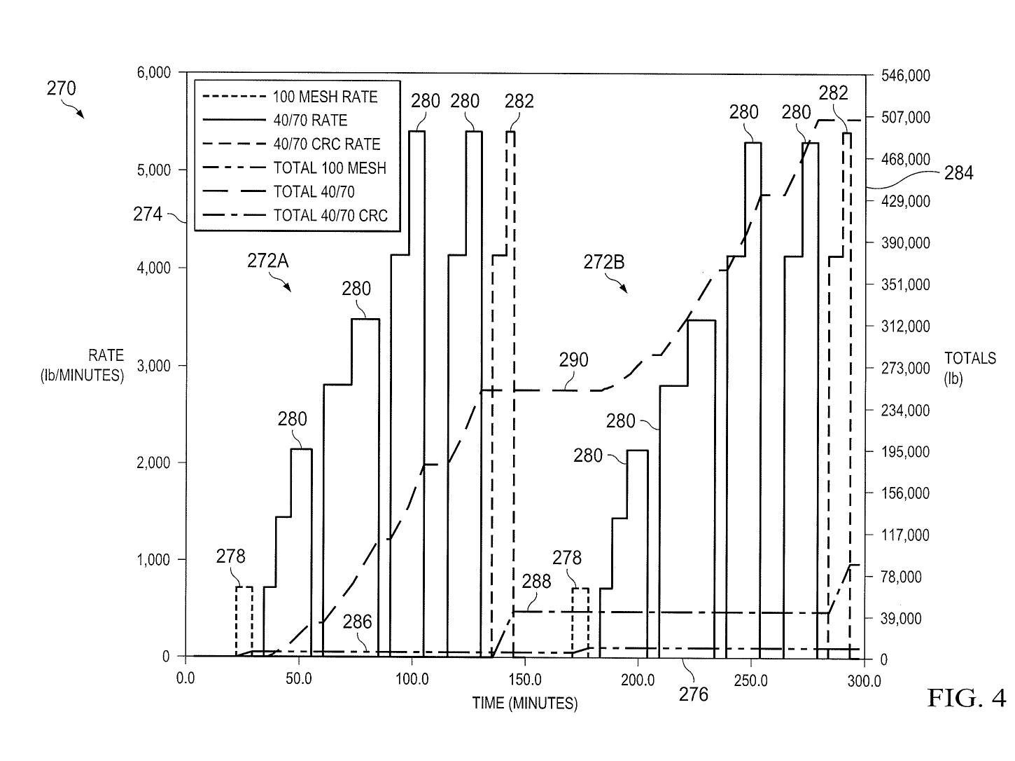

FIG. 4 provides a detailed illustration of an embodiment of a sand profile 270 that may be developed for a particular stimulation job. As illustrated in the sand profile 270, this stimulation job may utilize three different types of bulk material (proppant) that is pumped into the well as part of wellbore treatment. The bulk material types may include, for example, 100 mesh sand, 40/70 sand, and 40/70 curable resin-coated (CRC) sand. Other types of sand/proppant (or other bulk materials) may be present in sand profiles 270 corresponding to different stimulation jobs. The illustrated sand profile 270 represents a stimulation job having two treatment intervals 272A and 272B separated by a certain amount of time. However, other sand profiles 270 may have only one treatment interval (or several more treatment intervals). As shown, the sand profile 270 may include downtime between the treatment intervals 272 for planned maintenance, moving between zones, running perforation guns, etc.

The sand profile 270 tracks a sand usage rate 274 over time 276 for each of the different types of bulk material. For example, the sand profile 270 illustrates a sand usage rate 278 corresponding to the 100 mesh sand, a sand usage rate 280 corresponding to the 40/70 sand, and a sand usage rate 282 corresponding to the 40/70 CRC sand.

In the sand profile 270, each treatment interval 272 may include a number of pump/sand concentration stages. For example, each treatment interval 272 in the illustrated sand profile 270 may include 12 stages (i.e., periods of time) having different concentrations of sand and/or types of sand being pumped continuously into the well. Each of these stages has a different sand usage rate 274 and/or a different material type. Certain stages may be separated by a certain amount of time so that the system is not constantly pumping bulk material into the well.

In the illustrated embodiment, the sand usage rate 278 of 100 mesh sand indicates that the stimulation job may utilize the 100 mesh sand during the first stage of each treatment interval 272. The stimulation job may then utilize the 40/70 sand (sand usage rate 280) during the second through tenth stages of each treatment interval 272. The sand usage rate 280 may generally increase between the second and tenth stages to ramp up the concentration of sand in the treatment fluid. The stimulation job may then switch over to the 40/70 CRC sand (sand usage rate 282) during the eleventh and twelfth stages of each treatment interval 272. As shown, the sand usage rate 282 increases from the eleventh stage to the twelfth stage to increase the concentration of sand in the treatment fluid.

In addition to the sand usage rates 278, 280, and 282 for each bulk material type, the sand profile 270 may track the total amount of sand 284 to be used in the stimulation job with respect to time 276. For example, the illustrated sand profile 270 may plot a total amount 286 of 100 mesh sand used with respect to time, a total amount 288 of 40/70 sand used with respect to time, and a total amount 290 of 40/70 CRC sand used with respect to time.

Turning back to FIG. 3, the method 210 may also include importing (block 220) shipment time values. Shipment time values may include the distance, or travel time, between the job site and the sand supply source (e.g., sand plant, mine, trans-load, or sand container storage depot). The shipment time values may also take into account any expected delay times for a bulk material container to be filled at the supply source, offloaded at the job site, and reloaded with an empty container. Further, the shipment time values may take into account additional constraints on delivery such as, for example, inability of trailers to travel during certain hours of the day (due to restrictions on heavy traffic), rush hour or other expected traffic congestion, forecasted weather delays, and road closures.

Upon receiving the shipment time values, the control system 106 may use the sand profile and the shipment time values to determine a schedule (block 222) for what bulk material types should be loaded onto the structure at a given time. The sand profile may also be used to determine (block 224) the amount of time the flow of bulk material from each container will last given the sand use rate for that material.

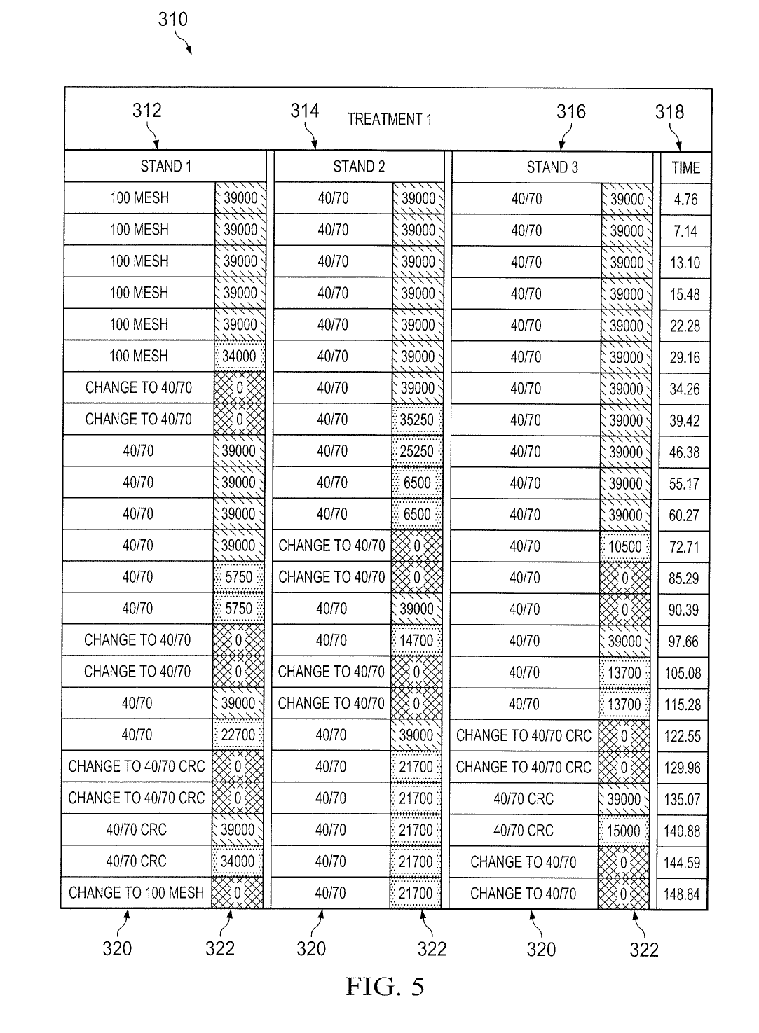

FIG. 5 is a chart illustrating a time study 310 of how the bulk material containers should be placed on the support structure for feeding into the blender to conform to the desired sand profile. The illustrated time study 310 is designed for a bulk material handling system where the support structure has three container receiving positions (Stands 1, 2, and 3). In the illustrated embodiment, the time study 310 is representative of the first treatment interval 272A of the sand profile 270 of FIG. 4.

The time study 310 includes three columns 312, 314, and 316 representing the three different positions, or docks, on the support structure, and a fourth column 318 representing the time in minutes. Each of the columns 312, 314, and 316 include a sand type indication 320 and a weight indication 322 that change with respect to time 318. The sand type 320 represents the type of bulk material present in a container on the corresponding stand of the support structure at a certain time. The weight 322 represents the amount of sand present in the container on the stand of the support structure at a certain time. The sand type indication 320 may occasionally change with respect to time on the same stand. For example, after the desired amount of 100 mesh sand is released from a container to the blender, the container may be closed, removed from the Stand 1 location of the support structure, and replaced with a container holding 40/70 sand during the time between 34.26 and 39.42 minutes.

The time study 310 illustrates the placement of portable containers having different types of materials on the Stands 1, 2, and 3 of the support structure, as well as the timing for releasing bulk material from the specific containers and for switching out containers. For example, when the weight indication 322 changes for a particular container on the support structure over a time period, this indicates that the container will be opened to release bulk material into the blender. The total sum of the weights 322 of all three containers on the support structure at a given time represent the connected capacity, or amount of material that is available on the support structure and operable for use in the blender.

Sometimes the amount of a bulk material needed at the blender at a particular time is less than the total amount available in the corresponding container. For example, as shown at time 29.16, only a portion of the available weight 322 of 100 mesh sand may be released into the blender before the partially full container is closed and removed from the support structure. In other instances, the full amount of material may be released from a container prior to removal and replacement of the container on the support structure.

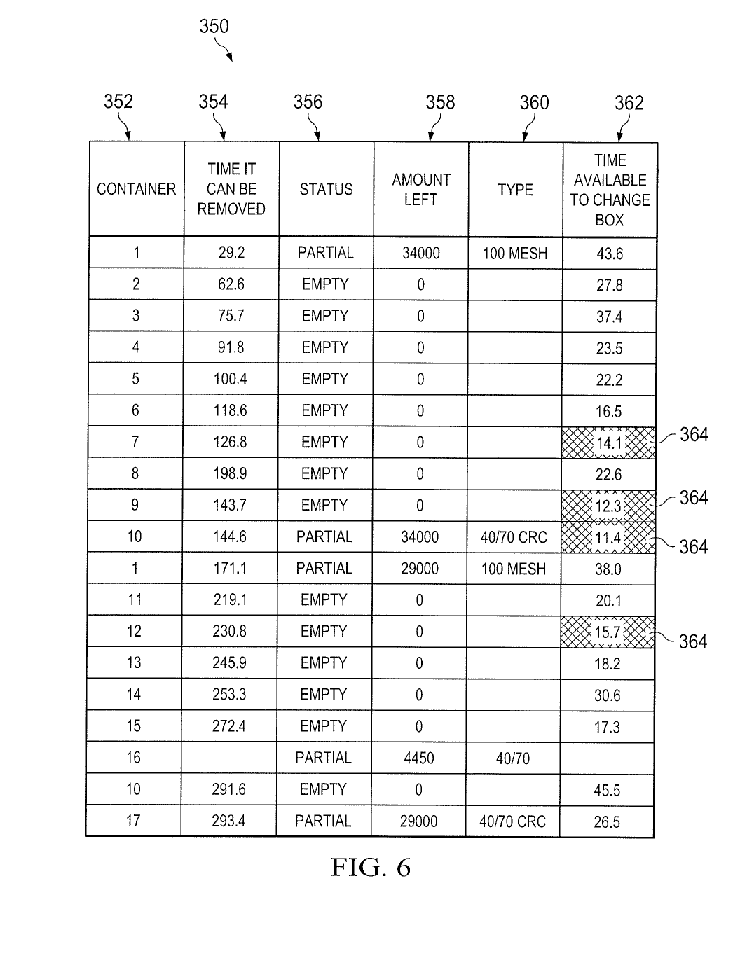

Turning back to FIG. 3, the method 210 may include determining a schedule (block 226) of when empty, or partially empty, bulk material containers should be removed from the structure and replaced with another container of bulk material. FIG. 6 is a chart 350 illustrating one such schedule that may be developed by the control system. The illustrated chart 350 pertains generally to the containers being moved on and off a single position on the support structure. However, the overall schedule may be developed by the control system to incorporate similar information for all container positions (e.g., 3 stands) on the structure.

The chart 350 includes a container identification 352, a time 354 for each container to be removed, a fill status 356 (e.g., partially full or empty) for each container at the time of removal, and an amount left 358 in each container at the time of removal. The chart 350 also includes a type of material 360 being supplied from each container to the blender, thereby indicating what type of material 360 should be put in the position on the support structure at a given time. In addition, the chart 350 may include a maximum time 362 available for the forklift driver (or other operator) to change out each of the containers with the next subsequent container without delaying the job. The times 354 and 362 may be expressed in minutes.

At some points in a treatment interval, the container swap times 362 may be relatively short, requiring that the forklift operator or other personnel perform the swap quickly. This may especially be the case when higher sand concentrations are desired in the stimulation job so that the treatment empties containers relatively quickly. Four of these relatively short swap times are indicated by the reference numeral 364 in the illustrated embodiment. At other points in the treatment interval, the swap times 362 may be relatively longer for performing certain container swaps (e.g., 43.6 minutes to swap container 1 for container 2, or 45.5 minutes to swap container 10 for container 11). For these longer swap times 362, the containers still need to be changed, but the swap is less urgent and time sensitive. This allows the forklift operator more freedom to perform other tasks about the well site during the swap time delay and still make the desired container swap in enough time.

As illustrated, some containers may be scheduled for removal from the support structure before they are fully emptied. These containers have a fill status 356 that reads “Partial”. In some cases, this may be because the container will be switched out for a container holding a different type of bulk material. In other instances, the container may be removed before it is emptied so that the forklift (or other hoisting mechanism) will be available for moving another container at a certain time. In general, the schedule may be optimized to minimize the number of times a container is moved while maximizing the amount of time between swapping containers on the support structure.

The control system may use the generated schedule to keep track of any partially emptied containers. In some cases, the control system 106 may provide information regarding which containers are partially or fully emptied to the inventory management system 104 of FIG. 2.

Turning back to FIG. 3, the method 210 may include determining (block 228) the number of container of each type of bulk material that are needed on location in order for the job to start. The control system 106 may determine these numbers based on several factors including, for example, the container swap schedule described above, the imported delivery time per container, a number of delivery trucks or truck drivers available, a number of containers available, and any regulatory information (e.g., specific delivery black-out time information). The delivery black-out time information may include the inability to deliver during certain hours of the day, expected road closures due to weather, time for driver changes and rest stops, and others. This information may also be used to determine (block 230) a schedule for each bulk material delivery to be made during the stimulation job. This schedule may include both the timing for arrival of the container delivery and the type of bulk material being delivered.

Using the number of containers (block 228) at the start and the schedule (block 230) for deliveries during the job, the control system 106 may construct a map of the inventory needed on location with respect to time. Although many of the container swaps and loading/unloading operations may be scheduled and/or automated, it is desirable to maintain a certain amount of extra inventory on location throughout the stimulation job. The desired number of containers (block 228) and delivery schedule (block 230) may be determined through an iterative process to reach a desired amount of extra inventory on location throughout the stimulation job. In some embodiments, the control system may design the schedule of containers on location such that at least one full pumping stage worth of bulk material is in reserve on location throughout the job. In other embodiments, the control system may design the schedule of containers on location such that at least one operational hour worth of bulk material is in reserve on location throughout the job. The desired quantity of reserve bulk material on location may be determined based on any number of job constraints and expectations.

The method 210 may then include calculating a total cost of sand delivery (block 232) for the stimulation job. This total cost of sand delivery may include both bulk material costs and delivery service costs. The total cost of sand delivery may be included in a job bid to potential customers. If desired, multiple job scenarios could be run using this method 210 to optimize the number of delivery trucks and total number of containers being used for the stimulation job. In addition, in some embodiments, the steps of the method 210 may be applied to situations where stimulation jobs are being performed on multiple wells at the same job site.

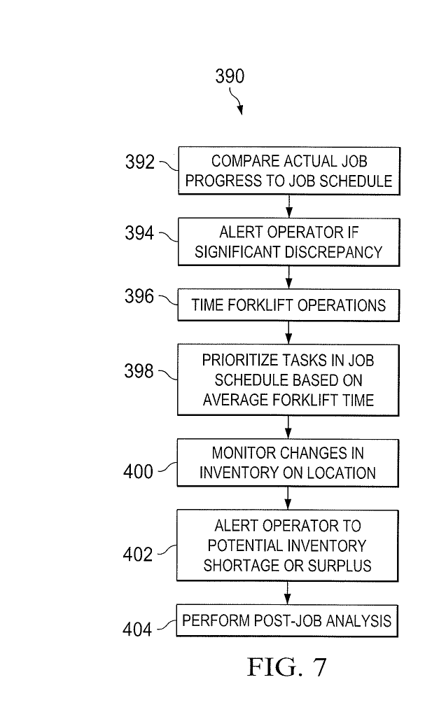

In addition to pre-planning and determining an optimized schedule for the stimulation job, the disclosed control system 106 may also be used to perform real-time monitoring and control operations of the bulk material handling system in accordance with the optimized schedule. FIG. 7 illustrates a method 390 for performing the real-time and post-job processing of the stimulation job via the control system 106. The objective of the real-time operations is generally to monitor the progress of the stimulation job, update the sand operator on what tasks should be performed next to keep the job running according to the pre-planned schedule, and provide warnings to the operator if delays are imminent. To accomplish this, the control system 106 may receive input from both the gate sequencing control system 90 and the on-location inventory management system 104, as illustrated in FIG. 2. The control system 106 may also receive input from multiple sensors 94 disposed about the job site to detect movement of bulk material containers. As shown, the control system 106 may output instructions to one or more operator interfaces 410 such as, for example, an interface for the sand operator at the well site, an interface for a forklift operator(s), or a combination thereof. In some embodiments, one or more of the operator interfaces 410 may be incorporated into forklifts 92.

In FIG. 7, the method 390 may include comparing (block 392) the progress of the actual stimulation job with the optimally designed job schedule. This may involve monitoring where the job is in relation to the designed job schedule at certain points throughout performing the stimulation job. For example, the control system 106 may monitor the progress of the job when each container swap is accomplished, when each treatment stage is completed, and when each new delivery of bulk material containers is received. The control system 106 may monitor the progress of the job based on feedback from the sensors (e.g., 94 of FIG. 2) throughout the job site and tracked with respect to time.

If major discrepancies are detected between the actual job and the optimized job schedule, the control system 106 may send a signal to the operator interface 410 to alert (block 394) the operator to the discrepancy. In some embodiments, the control system 106 may notify the operator of possible changes that can be made to the original schedule to correct the discrepancy. For example, the control system 106 may notify the operator to consider adjusting the delivery schedule based on the discrepancy.

In addition, the method 390 may include timing (block 396) each forklift operation performed on site. For example, each time a forklift performs an operation on site (e.g., removing a full container from a trailer, placing a container on the support structure, removing a container from the support structure, or placing an empty container on a trailer), the operation is timed by the control system 106. This timing may be determined based on sensor feedback received from sensors on the forklift or at other locations throughout the job site. The average time for a forklift driver (operator) to complete each operation may be continuously updated and stored within the control system 106.

The most updated average time for the forklift operations may be used to ensure that the most critical job tasks are scheduled with sufficient time to be accomplished without delaying the stimulation job. That is, the control system 106 may prioritize (block 398) tasks in the job schedule based partly on the sensed average timing for the forklift operators to perform certain operations. The control system 106 may rearrange the schedule based on the forklift driver's efficiency to place the less critical tasks further behind the more critical tasks.

An example of this prioritization process will now be provided. A trailer may arrive on location with a new container that needs to be unloaded, and an operator (or the control system 106) may send instructions to the forklift driver to unload the trailer. These instructions may include information regarding where to place the unloaded container in the inventory piles (e.g., container location determined by the container inventory tracking number). Before issuing the instructions, however, the control system 106 may check the state of each container on the support structure, as well as the job schedule, to determine if unloading the trailer at that time would delay the forklift driver from removing the next empty container from the support structure. If no delay is expected, given the average time for the forklift driver to accomplish the task of unloading the trailer, then the control system 106 will send the order to an operator interface (e.g., sand operator or forklift operator). If a delay is expected, the severity of the delay on each of the pending operations may be determined using a weighting factor that accounts for the current sand usage rate, the time for the second container to empty, and the possibility of detention fees if the trailer is left waiting too long before unloading. The control system 106 may then issue the task order with the minimum severity to the operator interface. A similar process can be followed for every required task throughout the stimulation job.

The method 390 may further include regularly monitoring (block 400) the changes in the on-location inventory database and conducting analysis of upcoming container swaps to identify any issues (e.g., shortages or surpluses) with inventory. The control system 106 may identify these issues with enough time to provide an alert (block 402) to the operator to correct the issues. As described above, a small amount of bulk material may be held in reserve, both in full and partially full containers, to provide a buffer in the bulk material handling system for unexpected events.

Once the stimulation job is completed, the control system 106 may perform post-job analysis (block 404) using data collected throughout the stimulation job via sensors. The post-job analysis may be run to improve the estimates for container handling time, delivery scheduling, forklift movements, and inventory management. This information may then be used to update the optimized planning model based on the real-time analysis of stimulation job operations.

Although the present disclosure and its advantages have been described in detail, it should be understood that various changes, substitutions and alterations can be made herein without departing from the spirit and scope of the disclosure as defined by the following claims.

What is claimed is:

1. A method, comprising:
receiving a job schedule at a control system, wherein the job schedule comprises information regarding treatment fluids to be mixed and output via a blender at a predetermined time;
determining, via the control system, an optimized schedule for movement of portable containers of bulk material based on the job schedule, wherein the optimized schedule comprises information regarding timing for placement of the containers onto a support structure that feeds bulk material from the containers into the blender and timing for removal of the containers from the support structure; and
outputting the optimized schedule from the control system to an operator interface.

2. The method of claim 1, wherein the optimized schedule further comprises information regarding a number of full or partially full portable containers at a job site, a number of empty portable containers at the job site, a number of portable containers or trailers in transit relative to the job site, or a total number of portable containers, forklift drivers, trailers, and truck drivers.

3. The method of claim 1, further comprising moving the containers according to the optimized schedule to facilitate mixing and outputting the treatment fluids via the blender according to the job schedule.

4. The method of claim 1, wherein the job schedule comprises a pumping rate, a bulk material concentration, and a bulk material type used in each stage of a treatment job.

5. The method of claim 1, further comprising:
constructing, via the control system, a sand use profile based on the job schedule, wherein the sand use profile comprises a sand usage rate and total amount of sand output;
receiving shipment time information at the control system; and
determining the optimized schedule based on the sand use profile and the shipment time information.

6. The method of claim 5, further comprising:
calculating a sand flow rate for each stage according to the job schedule;
calculating a time that the sand flow rate will be maintained for each stage according to the job schedule; and
constructing the sand use profile based on the sand flow rate and the time.

7. The method of claim 1, wherein the optimized schedule comprises a type of bulk material in each container to be loaded on the support structure, an amount of time a flow of bulk material from each container will last, a timing for removal of containers from the support structure, and a maximum time for a forklift driver to swap containers.

8. The method of claim 1, further comprising determining, via the control system, a number of containers of bulk material to be placed at the job site prior to beginning a job based on the optimized schedule and one or more delivery constraints.

9. The method of claim 8, wherein the one or more delivery constraints comprise a delivery time per container, a number of containers available, a number of delivery trailers available, or regulatory restrictions.

10. The method of claim 1, further comprising determining, via the control system, a container delivery schedule comprising an arrival time and a type of bulk material contents for each delivery, and outputting the container delivery schedule to the operator interface.

11. The method of claim 1, further comprising computing, via the control system, a total cost of bulk material delivery to supply material for a job based on the optimized schedule, and outputting the total cost to the operator interface.

12. A method, comprising:
developing an optimized schedule for movement of portable containers of bulk material to, from, or about a job site;
detecting, via sensors, data indicative of actual movements of the containers;
monitoring, via the control system, the actual movements of the containers based on the data detected by the sensors; and
outputting instructions via an operator interface coupled to the control system, the instructions comprising information regarding next steps to be performed to minimize a difference between the actual movements of the containers and the schedule.

13. The method of claim 12, further comprising comparing the actual movements of the containers to the schedule and outputting an alert via the operator interface if discrepancies between the timing of the actual movements and the schedule are above a threshold.

14. The method of claim 12, further comprising:
timing each forklift operation performed at the job site via the sensors;
updating and storing an average time for performing each forklift operation; and
determining the instructions to output based on the average time for performing a forklift operation.

15. The method of claim 12, further comprising:
determining two or more competing operations for the next steps to be performed;
assigning a weighting factor to each of the competing operations to determine a severity of delaying each operation; and
outputting the instructions to perform an operation having the lowest severity.

16. The method of claim 12, further comprising monitoring changes in bulk material inventory at the job site and outputting an alert via the operator interface in response to detecting a potential inventory shortage or surplus of bulk material.

17. The method of claim 12, further comprising performing a post-job analysis on the data indicative of the actual movements of the portable containers of bulk material after completing a job, and updating the schedule based on the post-job analysis.

18. A system, comprising:
a plurality of portable containers of bulk material, wherein the plurality of portable containers are separate from each other and independently transportable;
a plurality of sensors for detecting movement of the plurality of portable containers to, from, or about a job site;
an operator interface;
a processing component communicatively coupled to the plurality of sensors and the operator interface; and
a memory component containing a set of instructions that, when executed by the processing component, cause the processing component to:
determine an optimized schedule for moving the portable containers of bulk material to, from, or about the job site;
monitor movements of the containers based on data detected by the sensors; and
output instructions to the operator interface, the instructions comprising information regarding next steps to be performed to minimize a difference between the movements of the containers and the schedule.

19. The system of claim 18, further comprising a support structure for elevating the portable containers of bulk material above a blender; wherein the schedule comprises a timing for placement and removal of the portable containers on the support structure.

20. The system of claim 18, further comprising a gate sequencing controller communicatively coupled to the control system and an inventory management system communicatively coupled to the control system.
